(19) United States
(12) Patent Application Publication
(10) Pub. No.: US 2014/0310502 A1
(43) Pub. Date: Oct. 16, 2014

(54) MEMORY MANAGEMENT APPARATUS AND MEMORY MANAGEMENT METHOD THEREOF

(71) Applicant: Tung-Yao Lee, Yunlin County (TW)

(72) Inventor: Tung-Yao Lee, Yunlin County (TW)

(73) Assignee: FARADAY TECHNOLOGY CORP., Hsinchu (TW)

(21) Appl. No.: 13/902,992

(22) Filed: May 28, 2013

(30) Foreign Application Priority Data
Apr. 12, 2013 (TW) 102113065

(51) Int. Cl. G06F 12/10

(52) U.S. Cl. CPC G06F 12/1027
USPC 711/207

(57) ABSTRACT

A memory management apparatus and method thereof are disclosed. The memory management apparatus includes a micro translation look-aside buffers, a main translation look-aside buffer, a page address history table and a controller. The page address history table is used to record the space size information for a plurality of page table entry which are written to the main translation look-aside buffer. The controller decides to whether access a page table entry or not from the main translation look-aside buffer according to the page address history table.

### CROSS-REFERENCE TO RELATED APPLICATION

This application claims the priority benefit of Taiwan application serial no. 102113065, filed on Apr. 12, 2013. The entirety of the above-mentioned patent application is hereby incorporated by reference herein and made a part of this specification.

### BACKGROUND OF THE INVENTION

1. Field of the Invention

The invention generally relates to a memory management apparatus and a memory management method, and more particularly, to a memory management apparatus and a memory management method for reading a page table entry (PTE).

2. Description of Related Art

In a conventional computer device, the processor thereof will have a memory management unit therein in charge of mapping a virtual address produced by the processor to a physical address of a memory. Through the physical address, the processor then accesses the data in the physical memory storage unit (such as a dynamic memory and/or a disk drive). In the memory management unit, there is a so-called page table entry (PTE).

The above-mentioned PTE has different content depending on different applications, in which the PTE contains a space size information of the application therein. The contents in the PTE are to be set by the user according to the feature of the application, and it (i.e., the PTE) is stored in an external storage unit out of the processor. That is, at the time, when the memory management unit requires the PTE, the PTE is read from the external storage unit.

In order to reduce the event probability of requiring accessing the external storage unit to read PTEs, there is a so-called translation look-aside buffer (TLB) in the memory management unit. The TLB is used to store PTEs for the memory management unit to read, which reduces the event probability of requiring accessing the external storage unit to read PTEs.

In the field of conventional technology, a TLB is divided into two levels. When the memory management unit does not find out a required PTE in the TLB of the first level, the memory management unit searches the required PTE in the TLB of the second level. However, since the TLB of the second is constructed by the static memory, for each time, it reads one PTE only in the TLB of the second level so as to judge whether or not the required PTE exists. If the required TLB of the second level does not exist in the TLB of the second level, it needs to check over all the content in the TLB of the second level according to the space size information which the system may use. Therefore, the conventional looking up scheme is time-consumed too much and the efficiency of the system devise is reduced.

### SUMMARY OF THE INVENTION

The invention provides a memory management apparatus and a memory management method which are able to effectively reduce the time required for searching page table entries.

A memory management apparatus of the invention includes a micro translation look-aside buffer (micro TLB), a main translation look-aside buffer (main TLB), a page address history table and a controller. The page address history table is coupled between the micro TLB and the main TLB, and the page address history table is used for recording a plurality of space size information of a PTE written in the main TLB. The controller is coupled to the micro TLB, the main TLB and the page address history table, wherein the controller decides whether or not to access the main TLB for reading the PTE according to the information recorded in the page address history table.

A memory management method of the invention includes: receiving a reading requirement of a page table entry; providing a page address history table coupled between a micro TLB and a main TLB; and providing a controller to decide whether or not to access the main TLB for reading the PTE according to the information recorded in the page address history table, wherein the page address history table is for recording the space size information of a PTE written in the main TLB.

Based on the description above, the memory management apparatus and the memory management method provided by the invention can record the space size information of the PTE written into the main TLB according to the page address history table. When needing to read a PTE, through the record of the page address history table, the controller can be aware of that whether or not a information with the same space size as the size of the PTE to be read has been stored in the main TLB so as to accordingly search the main TLB. In this way, when there is no information with the same space size as the size of the PTE to be read stored in the main TLB, the searching operation of the main TLB can be saved, which effectively reduce the searching time of the main TLB.

In order to make the features and advantages of the present invention more comprehensible, the present invention is further described in detail in the following with reference to the embodiments and the accompanying drawings.

### BRIEF DESCRIPTION OF THE DRAWINGS

The accompanying drawings are included to provide a further understanding of the disclosure, and are incorporated in and constitute a part of this specification. The drawings illustrate embodiments of the disclosure and, together with the description, serve to explain the principles of the disclosure.

FIG. 1 is a blocks diagram of a memory management apparatus 100 according to an embodiment of the invention.

FIG. 2 is an implementation diagram of a page address history table 130 according to the embodiment of the invention.

FIG. 3 is a flowchart of a memory management method according to an embodiment of the invention.

FIG. 4 is a flowchart of a memory management method according to another embodiment of the invention.

FIG. 5 is another implementation diagram of a page address history table 500 in the embodiment of the invention.

### DESCRIPTION OF THE EMBODIMENTS

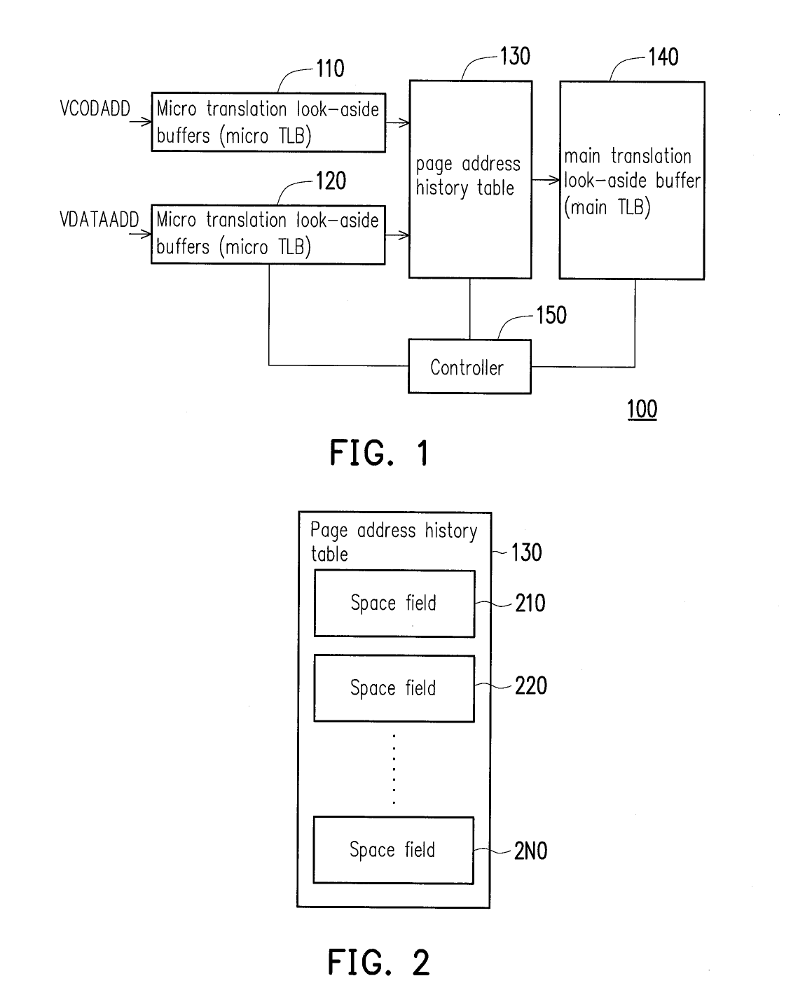

FIG. 1 is a block diagram of a memory management apparatus 100 according to an embodiment of the invention. Referring to FIG. 1, the memory management apparatus 100 includes two micro TLBs 110 and 120, a page address history table 130, a main TLB 140 and a controller 150. The micro TLBs 110 and 120 respectively receive a virtual address VCODADD and a virtual address VDATAADD, in which the virtual address VCODADD can be the virtual address of program code, while the virtual address VDATAADD can be the virtual address of data. When there is a need to looking up a PTE, the controller 150 of the memory management apparatus 100 will respectively look up the PTE in the micro TLB 110 and the micro TLB 120 according to the virtual addresses VCODADD and VDATAADD to ensure whether or not the required PTE is stored in the micro TLB 110 or 120.

The page address history table 130 is coupled between the micro TLB 110 and the main TLB 140 and between the micro TLB 120 and the main TLB 140. The page address history table 130 is used to record a plurality of space size information of PTEs written in the main TLB 140. When a required PTE can not be found out in the micro TLBs 110 and 120, the controller 150 will check the content of the page address history table 130. It should be noted that the page address history table 130 is used to record the space size information of PTEs written in the main TLB 140. That is, the controller 150 can judge out whether or not a space size information same as the size of the required PTE has been written in the main TLB according to the page address history table 130. If the page address history table 130 indicates the main TLB 140 has a PTE with the same space size information as the one of the required PTE written therein, the controller 150 further performs a looking up operation on the main TLB 140. Otherwise, if the page address history table 130 indicates the main TLB 140 has no such PTE with the same space size information as the one of the required PTE written therein, the controller 150 will not perform a looking up operation on the main TLB 140, instead, the required PTE will be directly read in an external storage device.

In following, the detail of the operation of the memory management apparatus 100 is explained. In the initial state, no information is stored in the micro TLBs 110 and 120, the main TLB 140 and the page address history table 130. When the virtual addresses VCODADD and VDATAADD are produced, at the time, the required PTE can not be found in the micro TLBs 110 and 120; and through the page address history table 130, the controller 150 is aware of that the required PTE can not be looked up in the main TLB 140 so that the required PTE should be read from the external storage device. Next, the obtained PTE read from the external storage device is written into the micro TLBs 110 and 120.

When newer virtual addresses VCODADD and VDATAADD are produced, the memory management apparatus 100 repeatedly performs the above-mentioned steps. Once the micro TLBs 110 and 120 are entirely filled, the controller 150 chooses an old required PTE in the micro TLBs 110 and 120 and moves the old required PTE into the main TLB 140. As a result, the micro TLB 110 or the micro TLB 120 gets newly added vacant storage space due to moving out the old required PTE, so that the controller 150 is able to write the required PTE into the newly added vacant storage space.

When the controller 150 performs an operation of writing the PTE into the main TLB 140, the controller 150 will also update the page address history table 130. Specifically, the space size information of the PTE written into the main TLB 140 is recorded to the page address history table 130.

It should be noted that the memory management apparatus 100 in the embodiment of the invention can have one constructed micro TLB only. In the embodiment, the implementation of two micro TLBs 110 and 120 is an embodiment example, which the invention is not limited to. In other embodiments of the invention, the micro TLBs 110 and 120 can be merged into a single micro TLB.

FIG. 2 is an implementation diagram of a page address history table 130 according to the embodiment of the invention. Referring to FIGS. 1 and 2, in FIG. 2, the page address history table 130 has a plurality of space fields 210-2N0 which are respectively corresponding to a plurality of different space sizes of page addresses. For example, the space fields 210-2N0 are respectively corresponding to different space sizes of page addresses of 1 KB, 4 KB, 16 KB, 64 KB and 1 MB.

The initial values of the space fields 210-2N0 can be set as “0”. When the space size of a PTE written in the main TLB 140 by the controller 150 is 4 KB, the controller 150 can set the space field in the page address history table 130 corresponding to the space size of 4 KB as “1” (for example, the space field 210). Thus, when there is a newly required PTE to be looked up, the controller 150 can be aware of that there is a PTE with the space size of 4 KB stored in the main TLB 140 according to the space field 210 set as “1”; if the space size of a newly required PTE is also equal to 4 KB, the controller 150 will perform a looking up operation of the newly required PTE on the main TLB 140.

On the contrary, when the space size of a newly required PTE is 8K, but the space field in the page address history table 130 corresponding to the space size of 8K is “0”, it indicates the main TLB 140 certainly does not have the newly required PTE. At the time, the controller 150 will not perform a looking up operation on the main TLB 140; instead, the controller 150 will directly read the newly required PTE in the external storage device. The page address history table 130 can have a plurality of space fields with “1” setting.

It should be noted that in order to indicate that there is a PTE with a space size corresponding to the space field stored in the main TLB 140, the space field of the page address history table 130 is not necessarily set as “1”. In fact, the designer can independently set the space field by any value with one bit or multiple bits so as to indicate whether or not the space field of the page address history table 130 is set already.

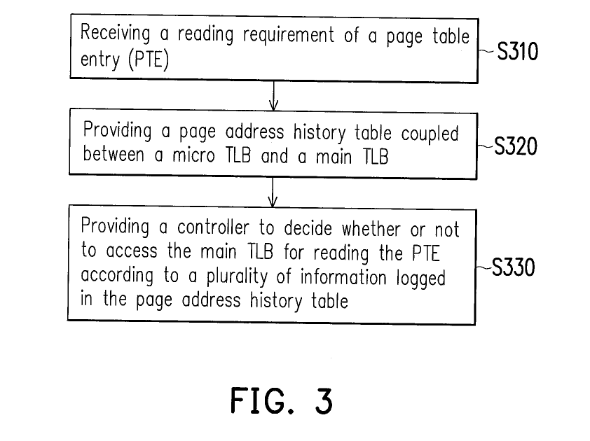

FIG. 3 is a flowchart of a memory management method according to an embodiment of the invention. Referring to FIG. 3, First in step S310, the memory management apparatus receives a reading requirement of a page table entry; Next in step S320, a page address history table coupled between a micro TLB and a main TLB is provided; then in step S330, it is decided through the controller whether or not to access the main TLB for reading the PTE according to the information recorded in the page address history table, wherein the page address history table is for recording the space size information of a PTE written in the main TLB.

The way for recording the space size information of a PTE written in the main TLB into the page address history table in the embodiment and the details of the above-mentioned steps can refer to the previous embodiment and its implementation, which is omitted to describe.

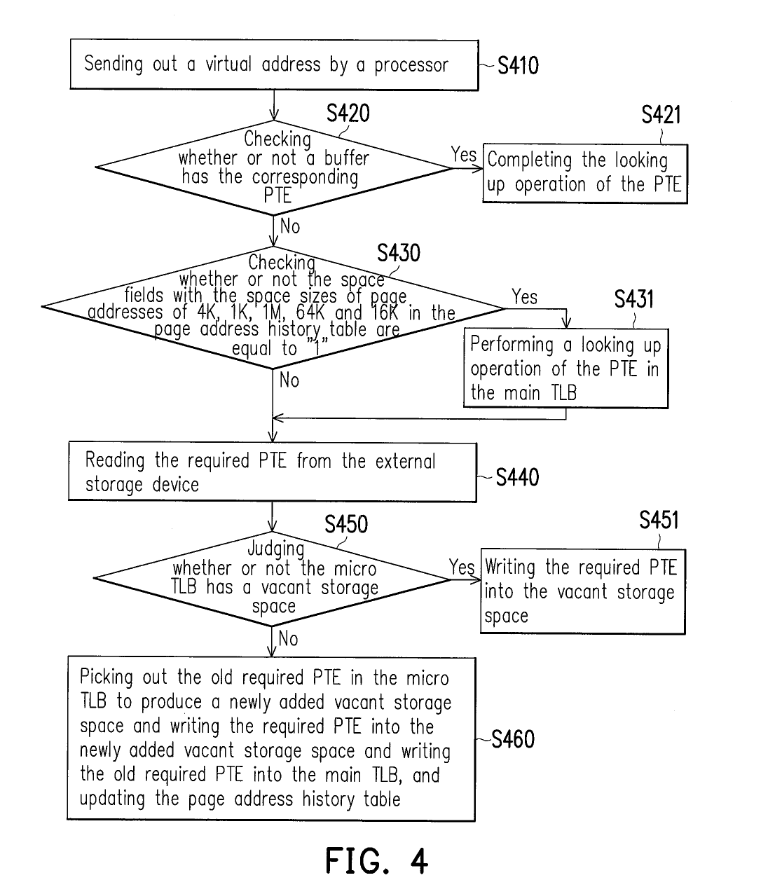

FIG. 4 is a flowchart of a memory management method according to another embodiment of the invention. Referring to FIG. 4, first in step S410, a processor sends out a virtual address; next in step S420, it is checked whether or not a buffer has the corresponding PTE, in which if the checking result is “yes”, it indicates the required PTE is found and the looking up operation of the PTE is completed (step S421). On the contrary, if the checking result of step S420 is “no”, it goes to step S430 where the space fields with the space sizes of page addresses of 4 KB, 1K, 1 M, 64 KB and 16K in the page address history table are checked to decide whether the space fields are set as “1”. If there is a space field set as 1 in the page address history table, it goes to step S431 to perform a looking up operation of the required PTE in the main TLB. It should be noted that when a plurality of ones among the above-mentioned space fields of space size information of the PTE are set as “1”, the looking up operation of the PTE can be performed on the main TLB in multiple times. In addition, if the required PTE can not be found through step S431, the procedure goes to step S440; if the required PTE can be found through step S431, the looking-up operation of the PTE is completed.

In step S430, if it is checked out that none of all the space fields in the page address history table is set as “1”, the procedure can goes to step S440. In step S440, the required PTE will be obtained through the external storage device.

Further, in step S450, it is judged whether or not the micro TLB has a vacant storage space. If the judgement result is “yes”, the procedure goes to step S451 so as to write the required PTE read in the external storage device into the vacant storage space. If the judgement result is “no”, the procedure goes to step S460 so as to pick out the old required PTE in the micro TLB to make the micro TLB produce a newly added vacant storage space and write the required PTE into the newly added vacant storage space and write the old required PTE into the main TLB. At the time, along with the writing operation on the main TLB, the page address history table should be updated accordingly.

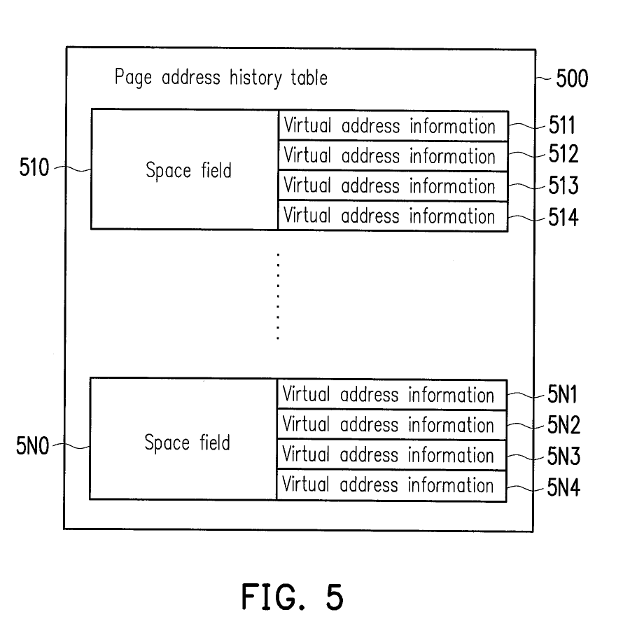

FIG. 5 is another implementation diagram of a page address history table 500 in the embodiment of the invention and the implementation of FIG. 5 is different from the implementation of the page address history table 130 shown in FIG. 2. Referring to FIG. 5, the page address history table 500 includes a plurality of space fields 510-5N0 and each of the space fields 510-5N0 includes a plurality of virtual address information. Taking the space fields 510 and 5N0 as exemplary examples. The space field 510 includes the virtual address information 511-514, while the space field 5N0 includes the virtual address information 5N1-5N4. In the implementation, during checking the page address history table 500, in addition to checking whether or not the space fields 510-5N0 have one/ones set as “1”, the virtual address information of the space field/fields set as “1” is also checked. Since different applications with a same space size may be arranged in different memory addresses. Therefore, by checking the virtual address information of the applications, it can be more clearly aware of whether or not the required PTE corresponding to an application can be looked up in the main TLB. If the controller decides by judgement that the virtual address produced by the processor can not be found in the virtual address information, the procedure can skip the looking up operation on the main TLB, which can further advance the memory management efficiency.

In summary, the invention provides a scheme of recording the space size information of the PTE written into the main TLB by using the page address history table, and by means of the page address history table, it can be decided whether or not to look up the PTE on the main TLB, which can avoid the entire reading operations on the main TLB, effectively save the looking up time of the PTE and increase access efficiency of the memory.

What is claimed is:

1. A memory management apparatus, comprising:
a micro translation look-aside buffer;
a main translation look-aside buffer;
a page address history table, coupled between the micro translation look-aside buffer and the main translation look-aside buffer, the page address history table recording a space size information of a page table entry written in the main translation look-aside buffer; and
a controller, coupled to the micro translation look-aside buffer, the main translation look-aside buffer and the page address history table, wherein the controller decides whether or not to access the main translation look-aside buffer for reading the page table entry according to the information recorded in the page address history table.

2. The memory management apparatus as claimed in claim 1, wherein the page address history table comprises a plurality of space fields, the space sizes are respectively corresponding to a plurality of different space sizes of page addresses, and each of the space fields is for recording whether or not the main translation look-aside buffer has a page table entry written therein and corresponding to each of the space sizes of the page addresses of each of the space fields.

3. The memory management apparatus as claimed in claim 2, wherein the space sizes of the page addresses are respectively 1 KB, 4 KB, 16 KB, 64 KB and 1 MB.

4. The memory management apparatus as claimed in claim 2, wherein each of the space fields further comprises a plurality of virtual address information.

5. The memory management apparatus as claimed in claim 2, wherein the controller further decides whether or not to access the main translation look-aside buffer for reading a page table entry according to the virtual address information of each of the space fields.

6. The memory management apparatus as claimed in claim 1, wherein when the information saved in the page address history table indicates the controller does not read a required page table entry from the main translation look-aside buffer, the controller reads the required page table entry from an external storage device.

7. The memory management apparatus as claimed in claim 6, wherein the controller further judges whether or not the micro translation look-aside buffer has a vacant storage space, and when the micro translation look-aside buffer has the vacant storage space, the controller writes the required page table entry into the vacant storage space.

8. The memory management apparatus as claimed in claim 6, wherein the controller further judges whether or not the micro translation look-aside buffer has a vacant storage space, when the micro translation look-aside buffer does not have the vacant storage space, an old required page table entry in the micro translation look-aside buffer is picked out to make the micro translation look-aside buffer produce a newly added vacant storage space and the controller writes the old required page table entry into the main translation look-aside buffer, updates the page address history table and writes the required page table entry into the newly added vacant storage space.

9. A memory management method, comprising:
receiving a reading requirement of a page table entry;
providing a page address history table coupled between a micro translation look-aside buffer and a main translation look-aside buffer; and
providing a controller to decide whether or not to access the main translation look-aside buffer for reading the page table entry according to information recorded in the page address history table,
wherein the page address history table is for recoding the space size information of a page table entry written in the main translation look-aside buffer.

10. The memory management method as claimed in claim 9, wherein the page address history table comprises a plurality of space fields, the space sizes are respectively corresponding to a plurality of different space sizes of page addresses, and each of the space fields is for recording whether or not the main translation look-aside buffer has a page table entry written therein and corresponding to each of the space sizes of the page addresses of each of the space fields.

11. The memory management method as claimed in claim 10, wherein the space sizes of the page addresses are respectively 1 KB, 4 KB, 16 KB, 64 KB and 1 MB.

12. The memory management method as claimed in claim 10, further comprising:
providing each of the space fields to record a plurality of virtual address information.

13. The memory management method as claimed in claim 12, further comprising:
providing the controller to decide whether or not to access the main translation look-aside buffer for reading a page table entry according to the virtual address information of each of the space fields.

14. The memory management method as claimed in claim 9, further comprising:
when the information recorded in the page address history table indicates the controller does not read a required page table entry from the main translation look-aside buffer; and
providing the controller to read the required page table entry from an external storage device.

15. The memory management method as claimed in claim 9, further comprising:
providing the controller to judge whether or not the micro translation look-aside buffer has a vacant storage space; and
when the micro translation look-aside buffer has the vacant storage space, providing the controller to write the required page table entry into the vacant storage space.

16. The memory management method as claimed in claim 9, further comprising:
providing the controller further to judge whether or not the micro translation look-aside buffer has a vacant storage space;
when the micro translation look-aside buffer does not have the vacant storage space, providing the controller to pick out an old required page table entry in the micro translation look-aside buffer to make the micro translation look-aside buffer produce a newly added vacant storage space; and
providing the controller to write the old required page table entry into the main translation look-aside buffer, update the page address history table and write the required page table entry into the newly added vacant storage space.
